(19) United States
(12) Patent Application Publication
(10) Pub. No.: US 2010/0026730 A1
(43) Pub. Date: Feb. 4, 2010

(54) Display device and driver

(75) Inventor: Shigeki Okutani, Shiga (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/458,942

(22) Filed: Jul. 28, 2009

(30) Foreign Application Priority Data
Aug. 1, 2008 (JP) 2008-199383

(51) Int. Cl. G09G 5/10; G09G 3/36

(52) U.S. Cl. 345/690; 345/204; 345/87

(57) ABSTRACT

A driver of a display device has an output buffer, a frame control circuit outputting a frame switch signal with respect to each frame, and an offset compensation control circuit outputting an offset compensation control signal to the output buffer in response to the frame switch signal. One frame includes a display period and a non-display period. In normal processing, the frame control circuit receives a first vertical synchronizing in one frame and outputs the frame switch signal from the receipt of the first vertical synchronizing signal to before the non-display period within the same frame. In special processing, the frame control circuit further receives a second vertical synchronizing signal in the non-display period in one frame, and further outputs the frame switch signal for a time from the receipt of the second vertical synchronizing signal to before the non-display period in the next frame.

### INCORPORATION BY REFERENCE

This application is based upon and claims the benefit of priority from Japanese patent application No. 2008-199383, filed on Aug. 1, 2008, the disclosure of which is incorporated herein in its entirety by reference.

### BACKGROUND OF THE INVENTION

1. Field of the Invention

The present invention relates to a display device and a driver thereof for displaying display data.

2. Description of Related Art

Display devices such as a TFT (Thin Film Transistor) liquid crystal display device, a passive matrix liquid crystal display device, an electroluminescence (EL) display device and a plasma display device have become widespread. Such a display device is provided with a display unit, a timing controller (controller IC) outputting a vertical synchronizing signal and display data, and a driver outputting the display data to the display unit in response to the vertical synchronizing signal.

The driver includes a gate driver (gate driver IC) and a source driver (source driver IC). In response to the vertical synchronizing signal supplied from the timing controller, the gate driver switches a frame to the next frame and then sequentially selects lines from the first line to the final line of the display unit. The source driver outputs the display data of one screen (one frame) to the display unit.

A method for achieving high-definition multiple-gray-scale display panel (display unit) is proposed. According to the method, the vertical synchronizing signal supplied to the gate driver is also supplied to the source driver as well. In response to the vertical synchronizing signal, the source driver compensates an offset voltage of an output of an output buffer (amplifier circuit). For example, according to a technique described in Japanese Laid-Open Patent Application JP-2002-108303, a frequency dividing circuit including a flip-flop frequency-divides the vertical synchronizing signal, and the offset voltage of the output of the output buffer is compensated with twice as much as a predetermined number of frames.

The inventor of the present application has recognized the following points.

In general, the number of vertical synchronizing signal pulse output by the timing controller is only one per one frame. However, there may be more than two vertical synchronizing signal pulses per one frame, depending on specification of the display device.

For example, the one vertical synchronizing signal pulse per one frame is used in a case of normal processing. In the case of normal processing, as mentioned above, the vertical synchronizing signal pulse is supplied also to the source driver, and the source driver compensates the offset voltage of the output of the output buffer in response to the vertical synchronizing signal pulse.

For example, two vertical synchronizing signal pulses per one frame are used in a case of special processing. Usually, one frame includes a display period and a non-display period. In the display period, the display unit is accessed and an image corresponding to the display data is displayed on the display unit. On the other hand, in the non-display period other than the display period, the display unit is usually not accessed. However, in the case of special processing, the display unit is accessed in the non-display period. For example, in the non-display period, the gate driver selects all pixels within the display unit, and the all pixels are discharged or a predetermined voltage is applied to the all pixels.

As described above, in the case of normal processing, one vertical synchronizing signal pulse per one frame needs to be supplied to the source driver. Whereas, in the case of special processing, two vertical synchronizing signal pulses per one frame need to be supplied to the gate driver.

Here, let us consider a display device that supports both of the normal processing and the special processing. In this case, the two vertical synchronizing signal pulses per one frame are supplied to the source driver, because the same vertical synchronizing signal is supplied to both of the gate driver and the source driver from the timing controller. However, the source driver is required to correctly recognize the frame switching based on the number of vertical synchronizing signals supplied from the timing controller. If the source driver cannot correctly recognize the frame switching, it causes problems with the normal processing.

It is desired to achieve a technique that can support both of the normal processing and the special processing even by using the same vertical synchronizing signal supplied from the timing controller.

### SUMMARY

In an aspect of the present invention, a driver is provided. The driver comprises: an output buffer configured to output gray-scale voltages corresponding to display data to a display unit; a frame control circuit configured to output a frame switch signal with respect to each frame; and an offset compensation control circuit configured to output an offset compensation control signal to the output buffer in response to the frame switch signal, the offset compensation control signal being for compensating an offset voltage of an output of the output buffer. One frame includes: a display period when an image corresponding to the display data is displayed on the display unit; and a non-display period other than the display period.

In a case of normal processing, the frame control circuit receives one vertical synchronizing signal in one frame period. The one vertical synchronizing signal is a first vertical synchronizing signal indicating start of a frame. The frame control circuit outputs the frame switch signal for a time from the receipt of the first vertical synchronizing signal to before the non-display period within the same frame.

In case of special processing where the display unit is accessed in the non-display period, the frame control circuit receives not only the first vertical synchronizing signal but also a second vertical synchronizing signal in the non-display period in one frame period. The frame control circuit outputs the frame switch signal for a time from the receipt of the first vertical synchronizing signal to before the non-display period within the same frame. Furthermore, the frame control circuit outputs the frame switch signal for a time from the receipt of the second vertical synchronizing signal to before the non-display period in the next frame.

In another aspect of the present invention, a display device is provided. The display device comprises: a display unit; a driver connected to the display unit; and a timing controller connected to the driver. The driver comprises: an output buffer configured to output gray-scale voltages corresponding to display data to the display unit; a frame control circuit configured to output a frame switch signal with respect to each frame; and an offset compensation control circuit configured to output an offset compensation control signal to the output buffer in response to the frame switch signal, the offset compensation control signal being for compensating an offset voltage of an output of the output buffer. One frame includes: a display period when an image corresponding to the display data is displayed on the display unit; and a non-display period other than the display period.

In a case of normal processing, the frame control circuit receives one vertical synchronizing signal in one frame period from the timing controller. The one vertical synchronizing signal is a first vertical synchronizing signal indicating start of a frame. The frame control circuit outputs the frame switch signal for a time from the receipt of the first vertical synchronizing signal to before the non-display period within the same frame.

In a case of special processing where the display unit is accessed in the non-display period, the frame control circuit receives not only the first vertical synchronizing signal but also a second vertical synchronizing signal in the non-display period in one frame period from the timing controller. The frame control circuit outputs the frame switch signal for a time from the receipt of the first vertical synchronizing signal to before the non-display period within the same frame. Furthermore, the frame control circuit outputs the frame switch signal for a time from the receipt of the second vertical synchronizing signal to before the non-display period in the next frame.

In still another aspect of the present invention, a method of operating a driver connected to a display unit is provided. The driver has an output buffer configured to output gray-scale voltages corresponding to display data to the display unit. One frame includes: a display period when an image corresponding to the display data is displayed on the display unit; and a non-display period other than the display period. The method includes: generating a frame switch signal with respect to each frame; and outputting an offset compensation control signal to the output buffer in response to the frame switch signal, the offset compensation control signal being for compensating an offset voltage of an output of the output buffer. The generating the frame switch signal is different between in a case of normal processing and in a case of special processing where the display unit is accessed in the non-display period.

The generating the frame switch signal in the case of the normal processing includes: receiving one vertical synchronizing signal in one frame period, wherein the one vertical synchronizing signal is a first vertical synchronizing signal indicating start of a frame; and generating the frame switch signal for a time from the receipt of the first vertical synchronizing signal to before the non-display period within the same frame.

The generating the frame switch signal in the case of special processing includes: receiving not only the first vertical synchronizing signal but also a second vertical synchronizing signal in the non-display period in one frame period; generating the frame switch signal for a time from the receipt of the first vertical synchronizing signal to before the non-display period within the same frame; and generating the frame switch signal for a time from the receipt of the second vertical synchronizing signal to before the non-display period in the next frame.

According to the present invention, in the case of the special processing where the second vertical synchronizing signal is supplied in the non-display period of one frame, the offset compensation control circuit can correctly recognize the frame switching based on the frame switch signal output by the frame control circuit. It is therefore possible to support both of the normal processing and the special processing even by using the same vertical synchronizing signal supplied from the timing controller.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 shows a configuration of a TFT liquid crystal display device 1 according to first and second embodiments of the present invention;

FIG. 2 shows a configuration of a source driver 30 of the TFT liquid crystal display device 1 according to the first and second embodiments of the present invention;

FIG. 3 shows a configuration of a driver of the TFT liquid crystal display device 1 according to the first embodiment of the present invention;

FIG. 4 is a timing chart showing an operation in the normal processing by the TFT liquid crystal display device 1 according to the first embodiment of the present invention;

FIG. 5 is a timing chart showing an operation in the special processing by the TFT liquid crystal display device 1 according to the first embodiment of the present invention;

FIG. 6 shows a configuration of a driver of the TFT liquid crystal display device 1 according to the second embodiment of the present invention; and

FIG. 7 is a timing chart showing an operation in the normal processing and the special processing by the TFT liquid crystal display device 1 according to the second embodiment of the present invention.

### DESCRIPTION OF PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

A display device and a driver thereof according to embodiment of the present invention will be described below in detail with reference to the attached drawings. The display device according to the present invention can be applied to a TFT (Thin Film Transistor) liquid crystal display device, a passive matrix liquid crystal display device, an electroluminescence (EL) display device, a plasma display device and the like.

### First Embodiment

[Configuration]

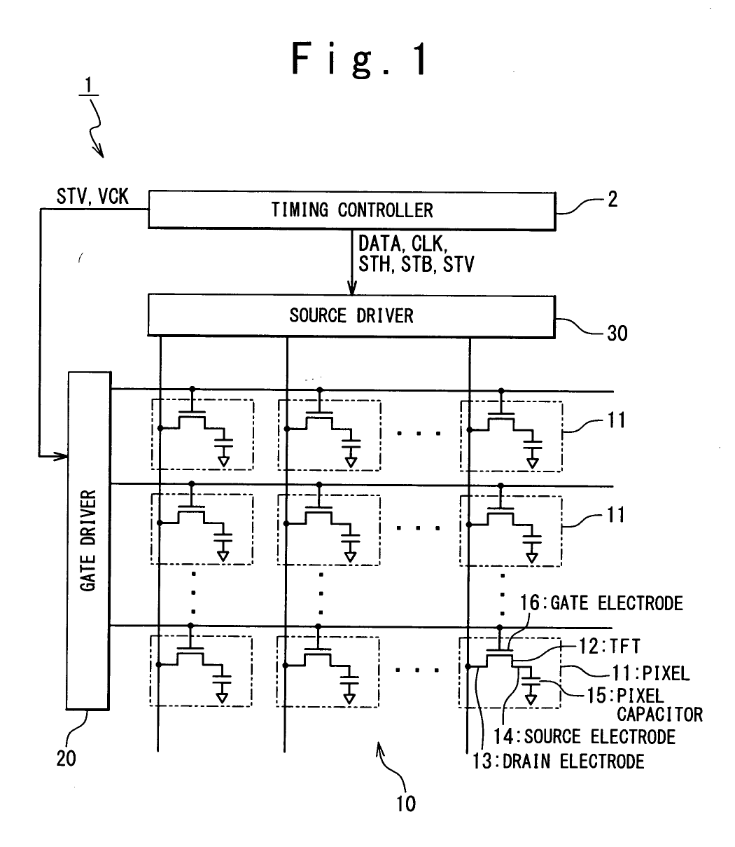

FIG. 1 shows a configuration of a TFT liquid crystal display device 1 as an example of a display device according to a first embodiment of the present invention.

The TFT liquid crystal display device 1 according to the present embodiment is provided with a display unit (liquid crystal panel) 10. The liquid crystal panel 10 has a plurality of pixels 11 that are arranged in a matrix form. Each of the plurality of pixels 11 has a TFT (Thin Film Transistor) 12 and a pixel capacitor 15. The pixel capacitor 15 has a pixel electrode and a common electrode facing the pixel electrode. The TFT 12 has a drain electrode 13, a source electrode 14 connected to the pixel electrode and a gate electrode 16.

The TFT liquid crystal display device 1 according to the present embodiment is further provided with a plurality of gate lines and a plurality of data lines. The plurality of gate lines are connected to gate electrodes 16 of TFTs 12 of pixels 11 arranged in respective rows. The plurality of data lines are connected to drain electrodes 13 of TFTs 12 of pixels 11 arranged in respective columns.

The TFT liquid crystal display device 1 according to the present embodiment is further provided with a driver for driving the plurality of pixels 11 of the liquid crystal panel 10. The driver includes a gate driver 20 and a source driver 30. The gate driver 20 is provided on a chip (not shown) and is connected to the plurality of gate lines. The source driver 30 is provided on the chip and is connected to the plurality of data lines.

The TFT liquid crystal display device 1 according to the present embodiment is further provided with a timing controller 2. The timing controller 2 is provided on the chip.

The timing controller 2 outputs a vertical clock signal VCK and a vertical shift pulse signal STV to the gate driver 20. The vertical clock signal VCK is a horizontal synchronizing signal having a cycle of one horizontal period. The vertical shift pulse signal STV is a vertical synchronizing signal having a cycle of one frame. The signals are used for sequentially selecting the plurality of gate lines from the first one to the final one. For example, in one horizontal period, the gate driver 20 outputs a selection signal to one of the plurality of gate lines in accordance with the vertical shift pulse signal STV and the vertical clock signal VCK, namely, selects one gate line. The selection signal is supplied to the gate electrodes 16 of the TFTs 12 of the pixels 11 connected to the selected one gate line, and the TFTs 12 are turned ON by the selection signal. The same applies to the other gate lines.

Also, the timing controller 2 outputs display data DATA, a clock signal CLK, a shift pulse signal STH and a latch signal STB to the source driver 30. The latch signal STB is a horizontal synchronizing signal having a cycle of one horizontal period. More specifically, the timing controller 2 outputs the display data DATA of the first line to the final line in this order to the source driver 30. The display data DATA of the first line to the final line corresponds to an image displayed on the liquid crystal panel 10 in one frame period.

The display data DATA of one line includes a plurality of display data associated with the plurality of data lines. The source driver 30 outputs the plurality of display data respectively to the plurality of data lines, in accordance with the shift pulse signal STH, the clock signal CLK and the latch signal STB. At this time, the TFTs 12 of the selected pixels 11 associated with the plurality of data lines and the one gate line among the plurality of gate lines are turned ON. Therefore, the plurality of display data are respectively applied to the pixel capacitors 15 of the selected pixels 11, and are maintained until the next time. Consequently, the display data DATA of one line is displayed.

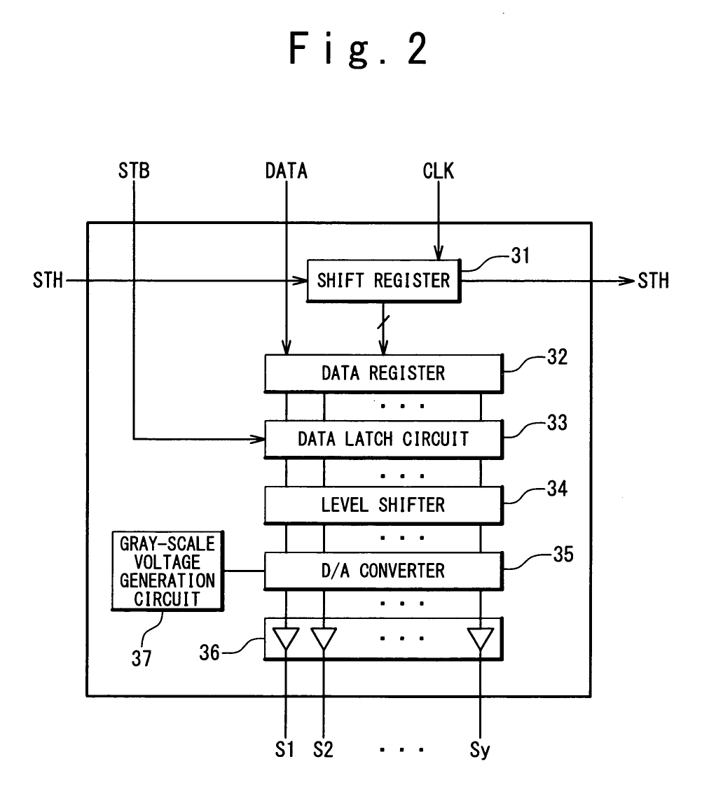

FIG. 2 shows a configuration of the source driver 30. The source driver 30 includes a shift register 31, a data register 32, a data latch circuit 33, a level shifter 34, a digital/analog (D/A) converter 35, an output buffer 36 and a gray-scale voltage generation circuit 37. The shift register 31 is connected to the data register 32, and the data register 32 is connected to the data latch circuit 33. The data latch circuit 33 is connected to the level shifter 34, and the level shifter 34 is connected to the D/A converter 35. The D/A converter 35 is connected to the output buffer 36 and the gray-scale voltage generation circuit 37. The output buffer 36 is connected to the plurality of data lines.

The gray-scale voltage generation circuit 37 includes a plurality of resistance elements that are serially connected one after another. The gray-scale voltage generation circuit 37 divides a reference voltage supplied from a power supply circuit (not shown) by using the plurality of resistance elements to generate a plurality of gray-scale voltages.

Next, an operation of the source driver 30 will be described below. Let us consider a case where a plurality of source drivers 30 are provided from the first stage to the final stage and the plurality of source drivers 30 are cascade-connected from the first stage to the final stage in this order in the row direction. Also, the plurality of source drivers 30 are connected to the display units 10, respectively. Each of the source drivers 30 is integrated on one chip as a driver IC. The timing controller 2 supplies the clock signal CLK, the latch signal STB and the display data DATA of one line to each source driver 30, and also supplies the shift pulse signal STH to the source driver 30 of the first stage. Each source driver 30 outputs the plurality of display data included in the display data DATA of one line respectively to the plurality of data lines, based on the clock signal CLK, the latch signal STB and the shift pulse signal STH.

In each source driver 30, the shift register 31 sequentially shifts the shift pulse signal STH in synchronization with the clock signal CLK and outputs it to the data register 32. The shift pulse signal STH is supplied to the next stage source driver 30 from an input or an output of the shift register 31. In the final stage source driver 30, the shift register 31 sequentially shifts the shift pulse signal STH in synchronization with the clock signal CLK and outputs it to the data register 32.

In each source driver 30, the data register 32 takes the plurality of display data supplied from the timing controller 2, in synchronization with the shift pulse signal STH supplied from the shift register 31. The data register 32 outputs the plurality of display data to the data latch circuit 33. The data latch circuit 33 latches the plurality of display data at the same timing in synchronization with the latch signal STB. The data latch circuit 33 outputs the plurality of display data to the level shifter 34. The level shifter 34 converts voltage level of the plurality of display data and then output them to the D/A converter 35. The D/A converter 35 performs digital/analog conversion with respect to the plurality of display data received from the level shifter 34. That is, the D/A converter 35 selects output gray-scale voltages corresponding to the plurality of display data supplied from the level shifter 34 and outputs the selected output gray-scale voltages to the output buffer 36. The output buffer 36 outputs the selected output gray-scale voltages respectively to the plurality of data lines of the display unit 10.

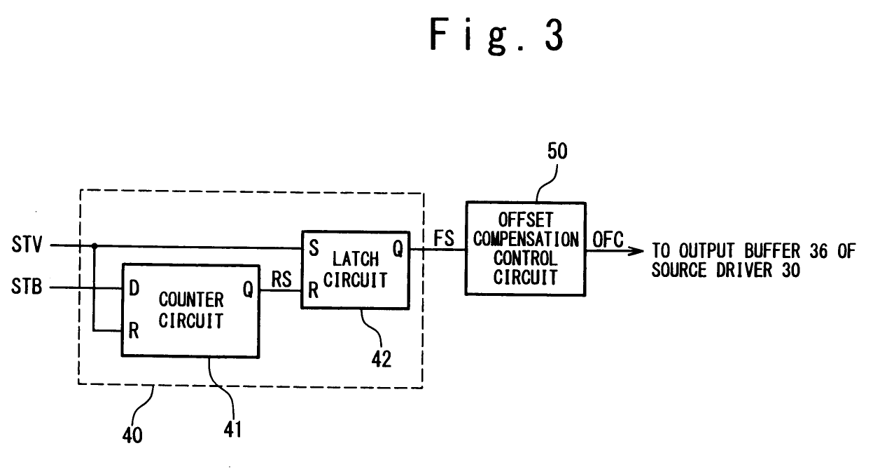

FIG. 3 shows a configuration of a driver (source driver 30). The driver is further provided with a frame control circuit 40 and an offset compensation control circuit 50. The frame control circuit 40 is configured to output a frame switch signal FS with respect to each frame. The frame control circuit 40 has a counter circuit 41 and a latch circuit 42.

The counter circuit 41 has a DATA input (D), a RESET input (R) and an output (Q). The DATA input (D) is connected to the timing controller 2 and the latch signal STB is supplied thereto from the timing controller 2. The RESET input (R) is connected to the timing controller 2 and the vertical shift pulse signal STV is supplied thereto from the timing controller 2. The counter circuit 41 outputs a reset signal RS from its output (Q) to the latch circuit 42.

The latch circuit 42 has a SET input (S), a RESET input (R) and an output (Q). The SET input (S) is connected to the timing controller 2 and the vertical shift pulse signal STV is supplied thereto from the timing controller 2. The RESET input (R) is connected to the output (Q) of the counter circuit 41 and the reset signal RS is supplied thereto from the output (Q) of the counter circuit 41. The latch circuit 42 outputs the frame switch signal FS from its output (Q) to the offset compensation control circuit 50.

An input of the offset compensation control circuit 50 is connected to the output (Q) of the latch circuit 42. An output of the offset compensation control circuit 50 is connected to the output buffer 36 in the source driver 30. The offset compensation control circuit 50 receives the frame switch signal FS from the frame control circuit 40. In response to the frame switch signal FS, the offset compensation control circuit 50 outputs an offset compensation control signal OFC to the output buffer 36 of the source driver 30. The offset compensation control signal OFC supplied to the output buffer 36 is for compensating an offset voltage of an output of the output buffer 36 of the source driver 30.

[Operation]

Next, an operation of the TFT liquid crystal display device 1 according to the present embodiment will be described below. The operation can be classified into an operation in the case of normal processing and an operation in the case of special processing. It should be noted that an overlapping description will be omitted as appropriate.

[Operation in the Normal Processing]

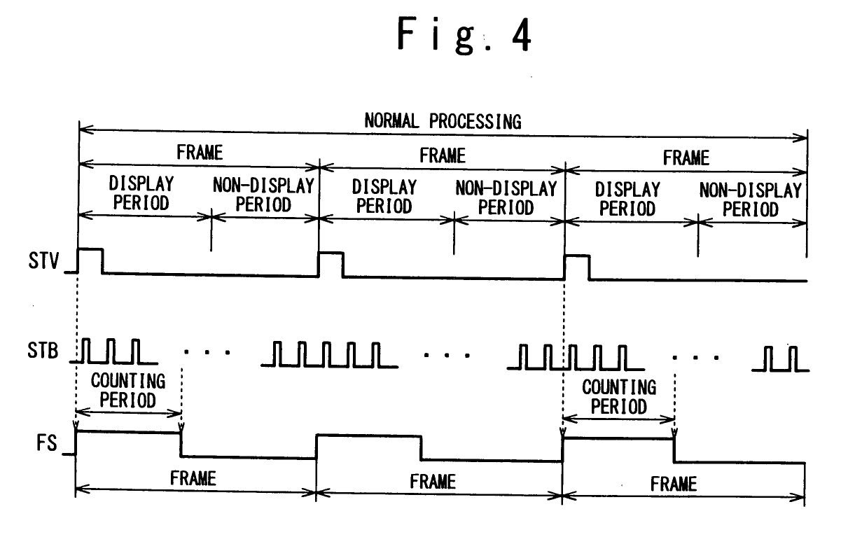

FIG. 4 is a timing chart showing an operation in the normal processing. As shown in FIG. 4, one frame is a period from a rise of a vertical shift pulse signal STV to a rise of the next vertical shift pulse signal STV. One frame includes a display period and a non-display period. In the display period, the liquid crystal panel 10 is accessed and an image corresponding to the display data is displayed on the liquid crystal panel 10. The non-display period is a period other than the display period. In the non-display period, an image corresponding to the display data is not displayed on the liquid crystal panel 10. It should be noted that a display time Ta corresponding to the display period is longer than a non-display time Tb corresponding to the non-display period (Ta>Tb).

The timing controller 2 outputs the latch signal STB as the horizontal synchronizing signal with respect to each horizontal period in a frame. The latch signal STB is a periodic pulse signal. In the display period in a frame, the timing controller 2 outputs one vertical shift pulse signal STV (first vertical synchronizing signal) which is a one-shot pulse signal indicating start of the frame (display period). The frame control circuit 40 receives the one vertical shift pulse signal STV from the timing controller 2.

Note that, in the example shown in FIG. 4, the non-display period exists only after the display period within one frame and the vertical shift pulse signal STV is generated in the display period. However, another non-display period may exist before the display period within one frame, and the vertical shift pulse signal STV may be generated in the non-display period before the display period.

In the display period in the frame, the counter circuit 41 resets a count value in response to a rise of the vertical shift pulse signal STV. After that, the counter circuit 41 performs the counting operation in accordance with the latch signal STB. Meanwhile, the latch circuit 42 becomes a “Set” state in response to the rise of the vertical shift pulse signal STV. In this case, the latch circuit 42 outputs the frame switch signal FS to the offset compensation control circuit 50. Specifically, the latch circuit 42 sets a signal level of the frame switch signal FS to the High-level “H”. Then, in response to the frame switch signal FS, the offset compensation control circuit 50 outputs the offset compensation control signal OFC to the output buffer 36 of the source driver 30.

In the display period in the frame, the counter circuit 41 performs the counting operation in accordance with the latch signal STB. If a time Td corresponding to the count value reaches a predetermined time Tc (Td=Tc), the counter circuit 41 outputs a reset signal RS to the latch circuit 42. The predetermined time Tc is longer than the non-display time Tb corresponding to the non-display period and shorter than the display time Ta corresponding to the display period (Tb<Tc<Ta). In response to the reset signal RS, the latch circuit 42 becomes a “Reset” state and hence stops the output of the frame switch signal FS. Specifically, the latch circuit 42 sets the signal level of the frame switch signal FS to the Low-level “L”.

In this manner, the frame control circuit 40 according to the present embodiment generates and outputs the frame switch signal FS in response to the one vertical shift pulse signal STV (first vertical synchronizing signal). More specifically, the frame control circuit 40 according to the present embodiment generates and outputs the frame switch signal FS for the predetermined time Tc after the receipt of the first vertical synchronizing signal, i.e., for a time from the receipt of the first vertical synchronizing signal to before the non-display period within the same frame.

The predetermined time Tc is designed as follows. For example, in the liquid crystal panel 10, several hundreds to several thousands of scanning lines are scanned during one frame, and several tens of scanning lines are scanned during the non-display period. In this case, the predetermined time Tc is set such that about hundred scanning lines are scanning in the predetermined time Tc.

[Operation in the Special Processing]

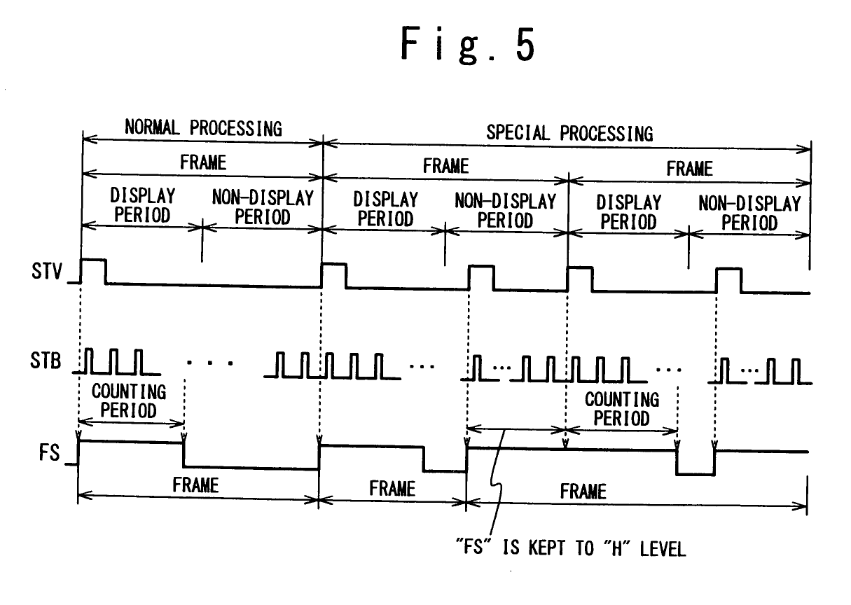

FIG. 5 is a timing chart showing an operation in the special processing. In the case of special processing, the liquid crystal panel 10 is accessed even in the non-display period in a frame. In the case of special processing, for example, the gate driver 20 selects all pixels 11 within the liquid crystal panel 10 in the non-display period, and the all pixels 11 (pixel capacitors 15) are discharged or a predetermined voltage is applied to the all pixels 11 (pixel capacitors 15).

In the case of special processing, the timing controller 2 further outputs another vertical shift pulse signal STV (second vertical synchronizing signal) which is a one-shot pulse signal. This vertical shift pulse signal STV is a special one and is output in the non-display period in a frame. That is to say, the timing controller 2 outputs not only the first vertical synchronizing signal in the display period but also the second vertical synchronizing signal in the non-display period in one frame. Within the one frame, the frame control circuit 40 receives the first vertical synchronizing signal in the display period and the second vertical synchronizing signal in the non-display period from the timing controller 2.

The operation in the display period in the frame is the same as in the case of the above-described normal processing. That is, the frame control circuit 40 generates and outputs the frame switch signal FS for the predetermined time Tc after the receipt of the first vertical synchronizing signal.

In the non-display period in the frame, the counter circuit 41 resets a count value in response to a rise of the vertical shift pulse signal STV (second vertical synchronizing signal). After that, the counter circuit 41 performs the counting operation in accordance with the latch signal STB. Meanwhile, the latch circuit 42 becomes the “Set” state in response to the rise of the vertical shift pulse signal STV (second vertical synchronizing signal). In this case, the latch circuit 42 outputs the frame switch signal FS to the offset compensation control circuit 50. Specifically, the latch circuit 42 sets a signal level of the frame switch signal FS to the High-level “H”. Then, in response to the frame switch signal FS, the offset compensation control circuit 50 outputs the offset compensation control signal OFC to the output buffer 36 of the source driver 30. Moreover, the gate driver 20 selects all pixels 11 within the liquid crystal panel 10, and the all pixels 11 are discharged or a predetermined voltage is applied to the all pixels 11.

In the non-display period in the frame, the counter circuit 41 performs the counting operation in accordance with the latch signal STB. As described above, the predetermined time Tc is longer than the non-display time Tb corresponding to the non-display period and shorter than the display time Ta corresponding to the display period (Tb<Tc<Ta). Therefore, the non-display period of the frame ends and the “next display period of the next frame” starts before the time Td corresponding to the count value reaches the predetermined time Tc (Td<Tc). The frame control circuit 40 receives the first vertical synchronizing signal indicating the start of the next frame (next display period), before the reset signal RS is generated.

In the display period in the next frame, the counter circuit 41 resets the count value in response to the rise of the vertical shift pulse signal STV (first vertical synchronizing signal). Then, the counter circuit 41 performs the counting operation in accordance with the latch signal STB. If the time Td corresponding to the count value reaches the predetermined time Tc (Td=Tc), the counter circuit 41 outputs the reset signal RS to the latch circuit 42. In response to the reset signal RS, the latch circuit 42 becomes a “Reset” state and hence stops the output of the frame switch signal FS. Specifically, the latch circuit 42 sets the signal level of the frame switch signal FS to the Low-level “L”.

In this manner, the frame control circuit 40 according to the present embodiment generates and outputs the frame switch signal FS from the receipt of the second vertical synchronizing signal in a frame to the receipt of the first vertical synchronizing signal indicating the start of the next frame and for the predetermined time Tc after the receipt of the first vertical synchronizing signal. That is, the frame control circuit 40 according to the present embodiment generates and outputs the frame switch signal FS continuously for a time from the receipt of the second vertical synchronizing signal to before the non-display period in the next frame. In other words, the frame switch signal FS is kept to the High-level “H” from the receipt of the second vertical synchronizing signal to the next frame, without returning back to the Low-level “L”.

[Effects]

Effects obtained by the driver and the TFT liquid crystal display device 1 according to the present embodiment are as follows.

In the normal processing, the frame control circuit 40 receives the vertical shift pulse signal STV (first vertical synchronizing signal) in the display period in a frame and then outputs the frame switch signal FS to the offset compensation control circuit 50 from the receipt of the vertical shift pulse signal STV (first vertical synchronizing signal) to before the non-display period. The offset compensation control circuit 50 can correctly recognize the frame based on the received frame switch signal FS. In response to the frame switch signal FS, the offset compensation control circuit 50 outputs the offset compensation control signal OFC to the output buffer 36 of the source driver 30. If the time Td corresponding the count value reaches the predetermined time Tc (Td=Tc), the frame control circuit 40 stops the output of the frame switch signal FS. As mentioned above, the predetermined time Tc is longer than the non-display time Tb and shorter than the display time Ta (Tb<Tc<Ta).

In the special processing, the frame control circuit 40 receives additional vertical shift pulse signal STV (second vertical synchronizing signal) in the non-display period in the frame. In this case, the frame control circuit 40 outputs the frame switch signal FS to the offset compensation control circuit 50 continuously for a time from the receipt of the second vertical synchronizing signal to before the non-display period in the next frame. The offset compensation control circuit 50 can correctly recognize the next frame based on the received frame switch signal FS. In response to the frame switch signal FS, the offset compensation control circuit 50 outputs the offset compensation control signal OFC to the output buffer 36 of the source driver 30. Although the timing at which the offset compensation control circuit 50 starts the compensation of the offset voltage of the output of the output buffer 36 becomes earlier, it does not affect the display unit (liquid crystal panel 10) at all, because the start timing is within the non-display period in the frame.

When the non-display period in the frame ends and the next display period in the next frame starts, the frame control circuit 40 continuously outputs the frame switch signal FS to the offset compensation control circuit 50, because the time Td corresponding to the count value does not reach the predetermined time Tc (Td<Tc). Moreover, when the next frame starts, the frame control circuit 40 restarts the counting operation. After that, when the time Td corresponding the count value reaches the predetermined time Tc (Td=Tc), the frame control circuit 40 stops the output of the frame switch signal FS.

As described above, according to the TFT liquid crystal display device 1 of the present embodiment, the frame control circuit 40 of the driver generates and outputs the frame switch signal FS with respect to each frame in response to the vertical shift pulse signal STV. Therefore, the offset compensation control circuit 50 can correctly recognize the frame switching based on the frame switch signal FS output by the frame control circuit 40. It is therefore possible to support both of the normal processing and the special processing even by using the vertical shift pulse signal STV supplied from the timing controller 2.

### Second Embodiment

In the TFT liquid crystal display device 1 according to a second embodiment of the present invention, two or more latch signals STB are supplied in at least one horizontal period among the first to the final horizontal periods in one frame. In other words, the latch signals STB supplied within one frame include not only a normal latch signal STB associated with each horizontal period but also a special latch signal STB (special horizontal synchronizing signal) different from the normal latch signal STB.

[Configuration]

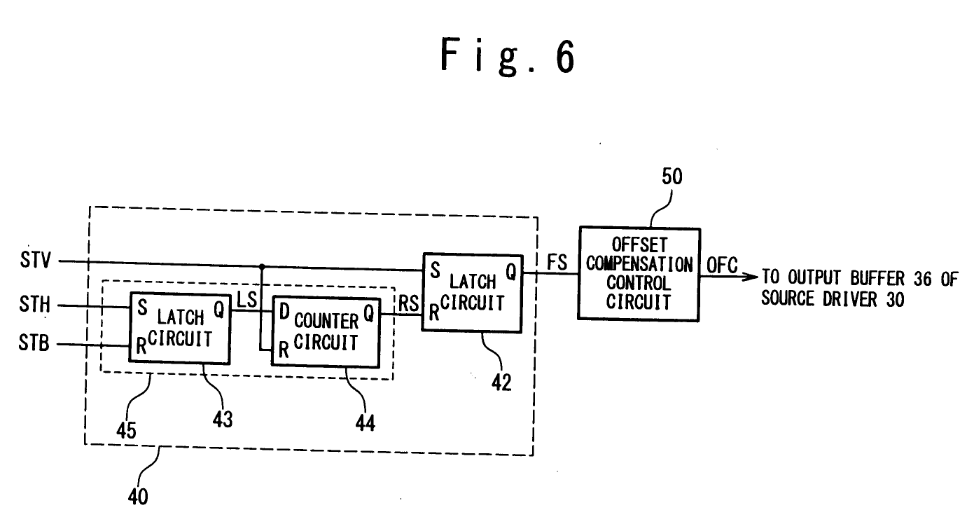

The same reference numerals are given to the same components as those described in the first embodiment, and an overlapping description will be omitted as appropriate. FIG. 6 shows a configuration of a driver (source driver 30) according to the second embodiment.

The frame control circuit 40 of the driver has a counter circuit 45 and the latch circuit 42. In other words, the counter circuit 41 described in the first embodiment is replaced by the counter circuit 45. The counter circuit 45 includes a line signal generating latch circuit 43 and a line signal counter circuit 44.

The line signal generating latch circuit 43 has a SET input (S), a RESET input (R) and an output (Q). With regard to the first stage source driver 30, the SET input (S) is connected to the timing controller 2 and the shift pulse signal STH is supplied thereto from the timing controller 2. With regard to the other source drivers 30, the SET input (S) is connected to the former stage source driver 30 and the shift pulse signal STH is supplied thereto from the former stage source driver 30. The RESET input (R) is connected to the timing controller 2 and the latch signal STB is supplied thereto from the timing controller 2. The line signal generating latch circuit 43 generates a periodic line signal LS by using the periodic shift pulse signal STH and the latch signal STB. The line signal generating latch circuit 43 outputs the line signal LS from its output (Q) to the line signal counter circuit 44.

The line signal counter circuit 44 has a DATA input (D), a RESET input (R) and an output (Q). The DATA input (D) is connected to the line signal generating latch circuit 43 and the line signal LS is supplied thereto from the line signal generating latch circuit 43. The RESET input (R) is connected to the timing controller 2 and the vertical shift pulse signal STV is supplied thereto from the timing controller 2. The line signal counter circuit 44 outputs the reset signal RS from its output (Q) to the latch circuit 42.

The latch circuit 42 has the SET input (S), the RESET input (R) and the output (Q). The connection relationship between the counter circuit 45 and the latch circuit 42 is similar to that in the first embodiment.

[Operation]

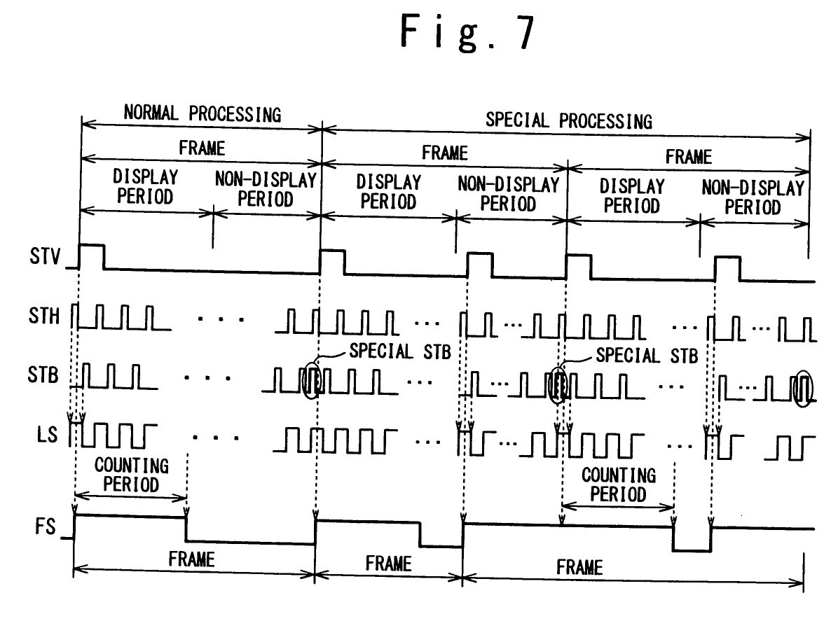

Next, an operation of the TFT liquid crystal display device 1 according to the present embodiment will be described below. As shown in FIG. 7, a normal latch signal STB is supplied in each horizontal period. Moreover, a special latch signal STB (special horizontal synchronizing signal) different from the normal latch signal STB is supplied in at least one horizontal period. For example, as shown in FIG. 7, two latch signals STB are supplied in the last one horizontal period. The first latch signal STB among the two latch signals STB is the normal one, while the second latch signal STB is the special one for use in the frame switching.

[Operation in the Normal Processing]

The line signal generating latch circuit 43 generates the line signal LS based on the shift pulse signal STH and the latch signal STB. As shown in FIG. 7, the line signal LS is at the High-level “H” from the rise of the shift pulse signal STH to the rise of the latch signal STB. The line signal generating latch circuit 43 outputs the line signal LS to the line signal counter circuit 44.

In the display period in the frame, the line signal counter circuit 44 resets a count value in response to the rise of the vertical shift pulse signal STV. After that, the line signal counter circuit 44 performs the counting operation in accordance with the line signal LS. Meanwhile, the latch circuit 42 becomes the “Set” state in response to the rise of the vertical shift pulse signal STV. In this case, the latch circuit 42 outputs the frame switch signal FS to the offset compensation control circuit 50. Specifically, the latch circuit 42 sets a signal level of the frame switch signal FS to the High-level “H”.

In the display period in the frame, the line signal counter circuit 44 performs the counting operation in accordance with the line signal LS. If a time Td corresponding to the count value reaches the predetermined time Tc (Td=Tc), the line signal counter circuit 44 outputs the reset signal RS to the latch circuit 42. In response to the reset signal RS, the latch circuit 42 becomes the “Reset” state and hence stops the output of the frame switch signal FS. Specifically, the latch circuit 42 sets the signal level of the frame switch signal FS to the Low-level “L”.

[Operation in the Special Processing]

The operation in the display period in the frame is the same as in the case of the above-described normal processing.

The line signal generating latch circuit 43 generates the line signal LS based on the shift pulse signal STH and the latch signal STB. As shown in FIG. 7, the line signal LS is at the High-level “H” from the rise of the shift pulse signal STH to the rise of the latch signal STB. The line signal generating latch circuit 43 outputs the line signal LS to the line signal counter circuit 44.

In the non-display period in the frame, the line signal counter circuit 44 resets a count value in response to the rise of the vertical shift pulse signal STV (second vertical synchronizing signal). After that, the line signal counter circuit 44 performs the counting operation in accordance with the line signal LS. Meanwhile, the latch circuit 42 becomes the “Set” state in response to the rise of the vertical shift pulse signal STV (second vertical synchronizing signal). In this case, the latch circuit 42 outputs the frame switch signal FS to the offset compensation control circuit 50. Specifically, the latch circuit 42 sets a signal level of the frame switch signal FS to the High-level “H”.

In the non-display period in the frame, the line signal counter circuit 44 performs the counting operation in accordance with the line signal LS. As described above, the predetermined time Tc is longer than the non-display time Tb corresponding to the non-display period and shorter than the display time Ta corresponding to the display period (Tb<Tc<Ta) Therefore, the non-display period of the frame ends and the “next display period of the next frame” starts before the time Td corresponding to the count value reaches the predetermined time Tc (Td<Tc). The frame control circuit 40 receives the first vertical synchronizing signal indicating the start of the next frame (next display period), before the reset signal RS is generated.

In the display period in the next frame, the line signal counter circuit 44 resets the count value in response to the rise of the vertical shift pulse signal STV (first vertical synchronizing signal). Then, the line signal counter circuit 44 performs the counting operation in accordance with the line signal LS. If the time Td corresponding to the count value reaches the predetermined time Tc (Td=Tc), the line signal counter circuit 44 outputs the reset signal RS to the latch circuit 42. In response to the reset signal RS, the latch circuit 42 becomes the “Reset” state and hence stops the output of the frame switch signal FS. Specifically, the latch circuit 42 sets the signal level of the frame switch signal FS to the Low-level “L”.

[Effects]

Effects obtained by the driver and the TFT liquid crystal display device 1 according to the present embodiment are as follows.

In the present embodiment, the normal latch signal STB and the special latch signal STB (special horizontal synchronizing signal) are supplied in at least one horizontal period. The frame control circuit 40 of the driver according to the present embodiment generates the periodic line signal LS based on the shift pulse signal STH and the latch signal STB, and outputs the frame switch signal FS by counting the periodic line signal LS instead of the latch signal STB. Therefore, the frame control circuit 40 is prevented from miscounting the special latch signal STB.

It is apparent that the present invention is not limited to the above embodiments and may be modified and changed without departing from the scope and spirit of the invention.

What is claimed is:

1. A driver comprising:
an output buffer configured to output gray-scale voltages corresponding to display data to a display unit;
a frame control circuit configured to output a frame switch signal with respect to each frame; and
an offset compensation control circuit configured to output an offset compensation control signal to said output buffer in response to said frame switch signal, said offset compensation control signal being for compensating an offset voltage of an output of said output buffer,
wherein one frame includes:
a display period when an image corresponding to said display data is displayed on said display unit; and
a non-display period other than said display period,
wherein in a case of normal processing, said frame control circuit receives one vertical synchronizing signal in one frame period, said one vertical synchronizing signal is a first vertical synchronizing signal indicating start of a frame, and said frame control circuit outputs said frame switch signal for a time from the receipt of said first vertical synchronizing signal to before said non-display period within the same frame, and
wherein in a case of special processing where said display unit is accessed in said non-display period, said frame control circuit receives not only said first vertical synchronizing signal but also a second vertical synchronizing signal in said non-display period in one frame period, said frame control circuit outputs said frame switch signal for a time from the receipt of said first vertical synchronizing signal to before said non-display period within the same frame and for a time from the receipt of said second vertical synchronizing signal to before said non-display period in the next frame.

2. The driver according to claim 1,
wherein said frame control circuit comprises:
a counter circuit; and
a latch circuit,
wherein said counter circuit resets a count value in response to said first vertical synchronizing signal and said second vertical synchronizing signal, performs a counting operation based on a horizontal synchronizing signal, and outputs a reset signal to said latch circuit if a time corresponding to said count value reaches a predetermined time,
wherein said latch circuit outputs said frame switch signal in response to said first vertical synchronizing signal and said second vertical synchronizing signal, and stops the output of said frame switch signal in response to said reset signal, and
wherein a display time corresponding to said display period is longer than a non-display time corresponding to said non-display period, and said predetermined time is longer than said non-display time and shorter than said display time.

3. The driver according to claim 2,
wherein in the case of said special processing, said counter circuit resets said count value in response to said second vertical synchronizing signal and then performs said counting operation, and said counter circuit resets said count value in response to said first vertical synchronizing signal indicating the start of said next frame before the time corresponding to said count value reaches said predetermined time,
wherein in said next frame, said counter circuit performs said counting operation, and outputs said reset signal when the time corresponding to said count value reaches said predetermined time.

4. The driver according to claim 2,
wherein said horizontal synchronizing signal includes a special horizontal synchronizing signal that is different from a normal horizontal synchronizing signal associated with each horizontal period,
wherein said counter circuit comprises:
a line signal generating latch circuit; and
a line signal counter circuit,
wherein said line signal generating latch circuit generates a periodic line signal by using a periodic shift pulse signal and said horizontal synchronizing signal, and outputs said periodic line signal to said line signal counter circuit,
wherein said line signal counter circuit resets said counter value in response to said first vertical synchronizing signal and said second vertical synchronizing signal, performs said counting operation in accordance with said periodic line signal, and outputs said reset signal to said latch circuit if the time corresponding to said count value reaches said predetermined time.

5. The driver according to claim 1,
wherein in said special processing, all pixels within said display unit are selected in said non-display period, and said all pixels are discharged or a predetermined voltage is applied to said all pixels.

6. A display device comprising:
a display unit;
a driver connected to said display unit; and
a timing controller connected to said driver,
wherein said driver comprises:
an output buffer configured to output gray-scale voltages corresponding to display data to said display unit;
a frame control circuit configured to output a frame switch signal with respect to each frame; and
an offset compensation control circuit configured to output an offset compensation control signal to said output buffer in response to said frame switch signal, said offset compensation control signal being for compensating an offset voltage of an output of said output buffer,
wherein one frame includes:
a display period when an image corresponding to said display data is displayed on said display unit; and
a non-display period other than said display period,
wherein in a case of normal processing, said frame control circuit receives one vertical synchronizing signal in one frame period from said timing controller, said one vertical synchronizing signal is a first vertical synchronizing signal indicating start of a frame, and said frame control circuit outputs said frame switch signal for a time from the receipt of said first vertical synchronizing signal to before said non-display period within the same frame, and
wherein in a case of special processing where said display unit is accessed in said non-display period, said frame control circuit receives not only said first vertical synchronizing signal but also a second vertical synchronizing signal in said non-display period in one frame period from said timing controller, said frame control circuit outputs said frame switch signal for a time from the receipt of said first vertical synchronizing signal to before said non-display period within the same frame and for a time from the receipt of said second vertical synchronizing signal to before said non-display period in the next frame.

7. The display device according to claim 6,
wherein said frame control circuit comprises:
a counter circuit; and
a latch circuit,
wherein said counter circuit resets a count value in response to said first vertical synchronizing signal and said second vertical synchronizing signal, performs a counting operation based on a horizontal synchronizing signal, and outputs a reset signal to said latch circuit if a time corresponding to said count value reaches a predetermined time,
wherein said latch circuit outputs said frame switch signal in response to said first vertical synchronizing signal and said second vertical synchronizing signal, and stops the output of said frame switch signal in response to said reset signal, and
wherein a display time corresponding to said display period is longer than a non-display time corresponding to said non-display period, and said predetermined time is longer than said non-display time and shorter than said display time.

8. The display device according to claim 7,
wherein in the case of said special processing, said counter circuit resets said count value in response to said second vertical synchronizing signal and then performs said counting operation, and said counter circuit resets said count value in response to said first vertical synchronizing signal indicating the start of said next frame before the time corresponding to said count value reaches said predetermined time,
wherein in said next frame, said counter circuit performs said counting operation, and outputs said reset signal when the time corresponding to said count value reaches said predetermined time.

9. The display device according to claim 7,
wherein said horizontal synchronizing signal includes a special horizontal synchronizing signal that is different from a normal horizontal synchronizing signal associated with each horizontal period,
wherein said counter circuit comprises:
a line signal generating latch circuit; and
a line signal counter circuit,
wherein said line signal generating latch circuit generates a periodic line signal by using a periodic shift pulse signal and said horizontal synchronizing signal, and outputs said periodic line signal to said line signal counter circuit,
wherein said line signal counter circuit resets said counter value in response to said first vertical synchronizing signal and said second vertical synchronizing signal, performs said counting operation in accordance with said periodic line signal, and outputs said reset signal to said latch circuit if the time corresponding to said count value reaches said predetermined time.

10. The display device according to claim 6,
wherein in said special processing, all pixels within said display unit are selected in said non-display period, and said all pixels are discharged or a predetermined voltage is applied to said all pixels.

11. A method of operating a driver connected to a display unit,
said driver comprising an output buffer configured to output gray-scale voltages corresponding to display data to said display unit,
one frame including: a display period when an image corresponding to said display data is displayed on said display unit; and a non-display period other than said display period,
the method comprising:
generating a frame switch signal with respect to each frame; and
outputting an offset compensation control signal to said output buffer in response to said frame switch signal, said offset compensation control signal being for compensating an offset voltage of an output of said output buffer,
wherein said generating said frame switch signal is different between in a case of normal processing and in a case of special processing where said display unit is accessed in said non-display period,
wherein said generating said frame switch signal in the case of said normal processing comprises:
receiving one vertical synchronizing signal in one frame period, wherein said one vertical synchronizing signal is a first vertical synchronizing signal indicating start of a frame; and
generating said frame switch signal for a time from the receipt of said first vertical synchronizing signal to before said non-display period within the same frame,
wherein said generating said frame switch signal in the case of special processing comprises:
receiving not only said first vertical synchronizing signal but also a second vertical synchronizing signal in said non-display period in one frame period;
generating said frame switch signal for a time from the receipt of said first vertical synchronizing signal to before said non-display period within the same frame; and
generating said frame switch signal for a time from the receipt of said second vertical synchronizing signal to before said non-display period in the next frame.

12. The method according to claim 11,
wherein said generating said frame switch signal comprises:
generating said frame switch signal in response to said first vertical synchronizing signal and said second vertical synchronizing signal;
resetting a count value in response to said first vertical synchronizing signal and said second vertical synchronizing signal;
performing a counting operation based on a horizontal synchronizing signal;
generating a reset signal if a time corresponding to said count value reaches a predetermined time; and
stopping the generation of said frame switch signal in response to said reset signal,
wherein a display time corresponding to said display period is longer than a non-display time corresponding to said non-display period, and said predetermined time is longer than said non-display time and shorter than said,display time.

13. The method according to claim 12,
wherein in the case of said special processing, said generating said frame switch signal comprises:
resetting said count value in response to said second vertical synchronizing signal and then performing said counting operation;
resetting said count value in response to said first vertical synchronizing signal indicating the start of said next frame before the time corresponding to said count value reaches said predetermined time; and
performing said counting operation in said next frame and generating said reset signal when the time corresponding to said count value reaches said predetermined time.

14. The method according to claim 12,
wherein said horizontal synchronizing signal includes a special horizontal synchronizing signal that is different from a normal horizontal synchronizing signal associated with each horizontal period,
wherein said performing said counting operation comprises:
generating a periodic line signal by using a periodic shift pulse signal and said horizontal synchronizing signal; and
performing said counting operation in accordance with said periodic line signal.

15. The method according to claim 11,
wherein in said special processing, all pixels within said display unit are selected in said non-display period, and said all pixels are discharged or a predetermined voltage is applied to said all pixels.
